(19) United States
(12) Patent Application Publication
(10) Pub. No.: US 2014/0001842 A1
(43) Pub. Date: Jan. 2, 2014

(54) Energy Converter for Outputting Electrical Energy

(71) Applicants: Stefan Butzmann, Beilstein (DE); Holger Fink, Stuttgart (DE)

(72) Inventors: Stefan Butzmann, Beilstein (DE); Holger Fink, Stuttgart (DE)

(73) Assignees: SB LiMotive Germany GmbH, Stuttgart (DE); SB LiMotive Company Ltd., Yongin-si Gyeonggi-do (KR)

(21) Appl. No.: 13/813,912

(22) PCT Filed: Jun. 7, 2011
(86) PCT No.: PCT/EP2011/059360

§ 371 Date: May 13, 2013

(30) Foreign Application Priority Data
Aug. 4, 2010 (DE) 10 2010 038 880.7

(51) Int. Cl. B60L 11/18

(52) U.S. Cl. CPC B60L 11/1803
USPC 307/10.1; 307/77

(57) ABSTRACT

An energy converter for outputting electrical energy includes at least one first converter cell module and at least one second converter cell module, which each comprise at least one converter cell and one coupling unit. The at least one converter cell is connected between a first input and a second input of the coupling unit. The coupling unit is configured to connect the at least one converter cell between a first terminal of the converter cell module and a second terminal of the converter cell module in response to a first control signal, and to connect the first terminal to the second terminal in response to a second control signal. The at least one converter cell of the first converter cell module is connected in a first polarity between the first input and the second input of the coupling unit of the at least one first converter cell module.

### PRIOR ART

It is apparent that battery systems will be used increasingly both in stationary applications and in vehicles such as hybrid vehicles and electric vehicles in future. In order to be able to meet the demands which are made for a respective application in terms of voltage and available power, a large number of battery cells are connected in series. Since the current provided by such a battery must flow through all the battery cells, and a battery cell can conduct only a limited current, battery cells are often additionally connected in parallel in order to increase the maximum current. This can be done either by providing a plurality of cell packages within a battery cell housing or by externally interconnecting battery cells.

FIG. 1 illustrates the basic circuit diagram of a conventional electric drive system as is used, for example, in electric and hybrid vehicles or else in stationary applications such as for rotor blade adjustment in wind power plants. A battery 110 is connected to a DC voltage intermediate circuit which is buffered by a capacitor 111. A pulse-controlled inverter 112 is connected to the DC voltage intermediate circuit and provides sinusoidal voltages, which are out of phase with respect to one another, at three outputs via in each case two switchable semiconductor valves and two diodes for the operation of an electric drive motor 113. The capacitance of the capacitor 111 must be large enough to stabilize the voltage in the DC voltage intermediate circuit for a period in which one of the switchable semiconductor valves is connected. In a practical application, such as an electric vehicle, a high capacitance is obtained in the mF range. Owing to the usually very high voltage of the DC voltage intermediate circuit, such a high capacitance can be realized only at great expense and with a large requirement in terms of space.

FIG. 2 shows the battery 110 from FIG. 1 in a more detailed block diagram. A multiplicity of battery cells are connected in series and optionally additionally in parallel in order to achieve a high output voltage and battery capacity which are desired for a respective application. A charging and disconnection device 116 is connected between the positive pole of the battery cells and a positive battery terminal 114. Optionally, a disconnection device 117 can additionally be connected between the negative pole of the battery cells and a negative battery terminal 115. The disconnection and charging device 116 and the disconnection device 117 each comprise a contactor 118 and, respectively, 119 which are provided for disconnecting the battery cells from the battery terminals in order to de-energize the battery terminals. Otherwise, there is considerable potential danger to servicing personnel or the like on account of the high DC voltage from the series-connected battery cells. A charging contactor 120 with a charging resistor 121 connected in series with the charging contactor 120 is additionally provided in the charging and disconnection device 116. The charging resistor 121 limits a charging current for the capacitor 111 when the battery is connected to the DC voltage intermediate circuit. For this purpose, the contactor 118 is initially left open and only the charging contactor 120 is closed. Once the voltage at the positive battery terminal 114 reaches the voltage of the battery cells, the contactor 119 can be closed and the charging contactor 120 may be opened. The contactors 118, 119 and the charging contactor 120 increase the costs of a battery 110 to a considerable extent since stringent demands are made of them in respect of reliability and the currents to be carried by them.

Insofar as reference is made in this document to batteries and battery cells as typical electrochemical energy converters or converter cells, at the same time other types of energy converter or converter cell which can output electrical energy may also be meant. This includes in particular photovoltaic energy converters such as solar cells.

### DISCLOSURE OF THE INVENTION

According to the invention, an energy converter for outputting electrical energy is therefore introduced. The energy converter has at least one first converter cell module and at least one second converter cell module which each comprise at least one converter cell and one coupling unit. The at least one converter cell is connected between a first input and a second input of the coupling unit. The coupling unit is configured to connect the at least one converter cell between a first terminal of the converter cell module and a second terminal of the converter cell module in response to a first control signal, and to connect the first terminal to the second terminal in response to a second control signal. According to the invention, the at least one converter cell of the at least one first converter cell module is connected in a first polarity between the first input and the second input of the coupling unit of the at least one first converter cell module and the at least one converter cell of the at least one second converter cell module is connected in a second polarity, which is opposite to the first polarity, between the first input and the second input of the coupling unit of the at least one second converter cell module.

The coupling unit makes it possible to couple one or more converter cells, which are connected between the first and the second input, either to the first and the second output of the coupling unit such that the voltage of the converter cells is available externally, or else to bypass the converter cells by connecting the first output to the second output, with the result that a voltage of 0 V is visible from the outside.

In this way, by means of suitable control of the coupling units of the series-connected converter cell modules, it is possible to set a variable output voltage for the energy converter by simply activating (voltage of the converter cells visible at the output of the coupling unit) or deactivating (output voltage of the coupling unit 0 V) an appropriate number of the converter cell modules. By providing converter cell modules having a first polarity and converter cell modules having an opposite second polarity within the energy converter, it becomes possible to generate a bipolar output voltage for the energy converter. The bipolar output voltage can be used, for example, to prescribe the direction of rotation of a DC voltage motor.

The invention offers the advantages that in this way the function of the pulse-controlled inverter from the prior art can be undertaken by the energy converter and a buffer capacitor for buffering a DC voltage intermediate circuit becomes superfluous and can be dispensed with. The energy converter of the invention can therefore be connected directly to an electric consumer which requires an AC voltage as a supply voltage.

In the extreme case, each converter cell module has only one converter cell or just one set of converter cells connected in parallel. This arrangement permits the finest setting of the output voltage of the energy converter. If, as generally preferred within the scope of the invention, lithium-ion battery cells having a cell voltage between 2.5 V and 4.2 V are used as converter cells, then the output voltage of the battery can be set with corresponding accuracy. The more accurately the battery output voltage can be set, the less significant the issue of electromagnetic compatibility will be, as the radiation generated by the battery current will fall in proportion to the high-frequency components thereof. However, this is achieved at the cost of more complex circuitry which, given the use of multiple switches, is also associated with increased power losses in the switches of the coupling units.

Preferably, the energy converter has a control unit, which is configured to output the first control signal to the at least one first converter cell module and to output the second control signal to the at least one second converter cell module during a first period. The control unit is also configured to output, in a second period following the first period, the second control signal to the at least one first converter cell module and to output the first control signal to the at least one second converter cell module and thus to set an output voltage for the energy converter to have a first arithmetic sign during the first period and to have a second arithmetic sign, which is opposite to the first arithmetic sign, during the second period.

If the control unit is integrated into the energy converter, the energy converter can function independently and generate an output voltage with alternating arithmetic signs.

Particularly preferably, the energy converter has a plurality of first converter cell modules and a plurality of second converter cell modules. In this arrangement, the control unit can be configured to set a sinusoidal output voltage. Sinusoidal output voltages allow components which were designed for operation on an AC voltage power supply to be connected directly. In this context, a stepped signal, which approximates a sinusoid with as little error as possible, is also to be understood as being “sinusoidal”. The higher the number of first and second converter cell modules in the energy converter, the smaller the steps based on the amplitude of the output voltage.

Preferably, the control unit is additionally also configured to set the sinusoidal output voltage to have a predefinable frequency. As a result, parameters which are dependent on the frequency of the supply voltage in a system connected to the energy converter can be predefined. It is also easily possible to integrate an energy converter of this type into a control system which synchronizes the output voltage of the energy converter to the voltage of a power supply system.

The coupling unit can have a first output and be configured to connect either the first input or the second input to the output in response to the first control signal. In this case, the output is connected to one of the terminals of the converter cell module and either the first or the second input is connected to the other of the terminals of the converter cell module. A coupling unit of this type can be realized using just two switches, preferably semiconductor switches such as MOSFETs or IGBTs.

Alternatively, the coupling unit can have a first output and a second output and be configured to connect the first input to the first output and the second input to the second output in response to the first control signal. At the same time, the coupling unit is also configured to disconnect the first input from the first output and the second input from the second output and to connect the first output to the second output in response to the second control signal. This embodiment requires somewhat greater circuit complexity (usually three switches), but it decouples the converter cells of the converter cell module from both poles thereof. This offers the advantage that, in the event of one converter cell module being damaged, the converter cells thereof can be de-energized and thus can be safely replaced while the overall arrangement continues to operate.

A second aspect of the invention relates to a motor vehicle having an electric drive motor for driving the motor vehicle and having an energy converter according to the first aspect of the invention, which is connected to the drive motor.

A third aspect of the invention introduces a method for supplying power to an electric drive system. The method has at least the following steps of:
a) providing an energy converter according to the first aspect of the invention;
b) connecting the energy converter to an electric drive system; and
c) setting an output voltage for the energy converter to have a first arithmetic sign during a first period and to have a second arithmetic sign, which is opposite to the first arithmetic sign, during a second period.

### DRAWINGS

Exemplary embodiments of the invention are explained in more detail with reference to the drawings and the description below, wherein the same reference numerals denote components which are the same or which have the same type of function. In the drawings:

FIG. 1 shows an electric drive system according to the prior art,

FIG. 2 shows a block diagram of a battery according to the prior art,

FIG. 3 shows a first embodiment of a coupling unit for use in the energy converter according to the invention,

FIG. 4 shows a possible circuit implementation of the first embodiment of the coupling unit,

FIGS. 5 and 6 show two embodiments of a converter cell module with the first embodiment of the coupling unit,

FIG. 7 shows a second embodiment of a coupling unit for use in the energy converter according to the invention,

FIG. 8 shows a possible circuit implementation of the second embodiment of the coupling unit,

FIG. 9 shows an embodiment of a converter cell module with the second embodiment of the coupling unit,

FIGS. 10 to 13 show embodiments of the energy converter according to the invention, and

FIG. 14 shows a temporal profile for an output voltage of the energy converter according to the invention.

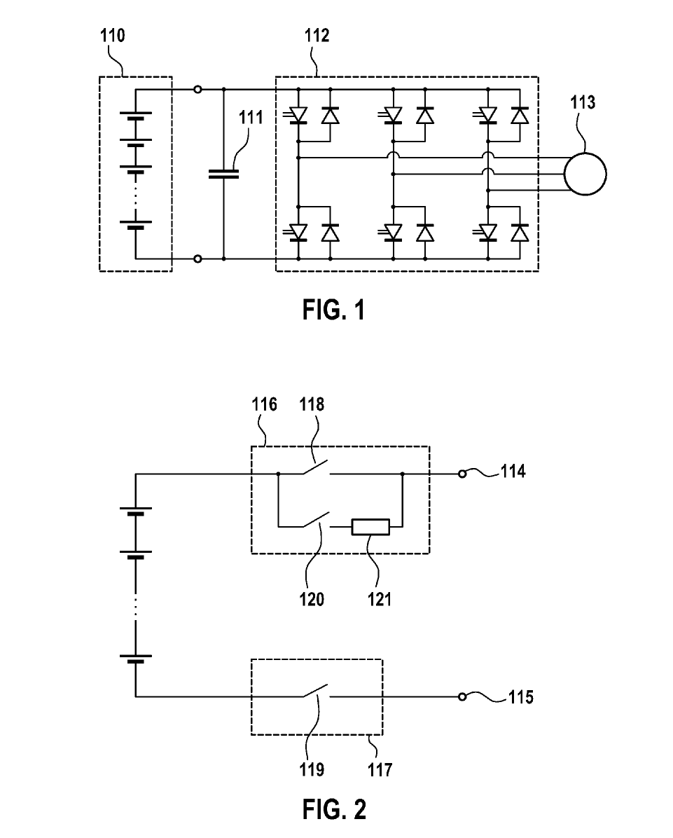

### EMBODIMENTS OF THE INVENTION

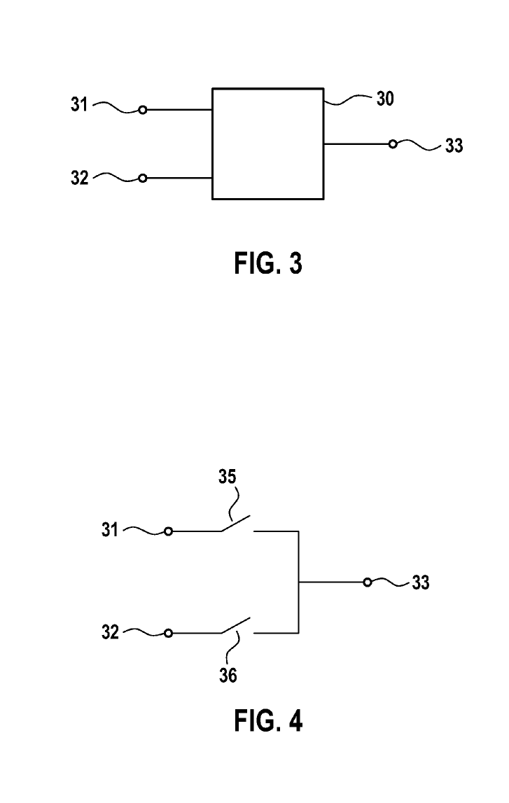

FIG. 3 shows a first embodiment of a coupling unit 30 for use in the energy converter according to the invention. The coupling unit 30 has two inputs 31 and 32 and an output 33 and is configured to connect one of the inputs 31 or 32 to the output 33 and to decouple the other input.

FIG. 4 shows a possible circuit implementation of the first embodiment of the coupling unit 30, in which a first and a second switch 35 and, respectively, 36 are provided. Each of the switches 35, 36 is connected between one of the inputs 31 or, respectively, 32 and the output 33. This embodiment offers the advantage that both inputs 31, 32 are also able to be decoupled from the output 33, with the result that the output 33 adopts a high-impedance state, which can be useful in the event of a repair or maintenance, for example. In addition, the switches 35, 36 can be realized simply as semiconductor switches such as MOSFETs or IGBTs. Semiconductor switches have the advantage of being cheap and having a high switching speed, such that the coupling unit 30 can react to a control signal or to a change in the control signal within a short period of time and high switching rates are achievable. Compared to a conventional pulse-controlled inverter, which generates a desired voltage waveform through appropriate selection of a duty ratio between maximum and minimum DC voltage (pulse-width modulation), the invention has the advantage that the switching frequencies of the switches used in the coupling units are substantially lower, such that the electromagnetic compatibility (EMC) is improved and lower demands can be placed on the switches.

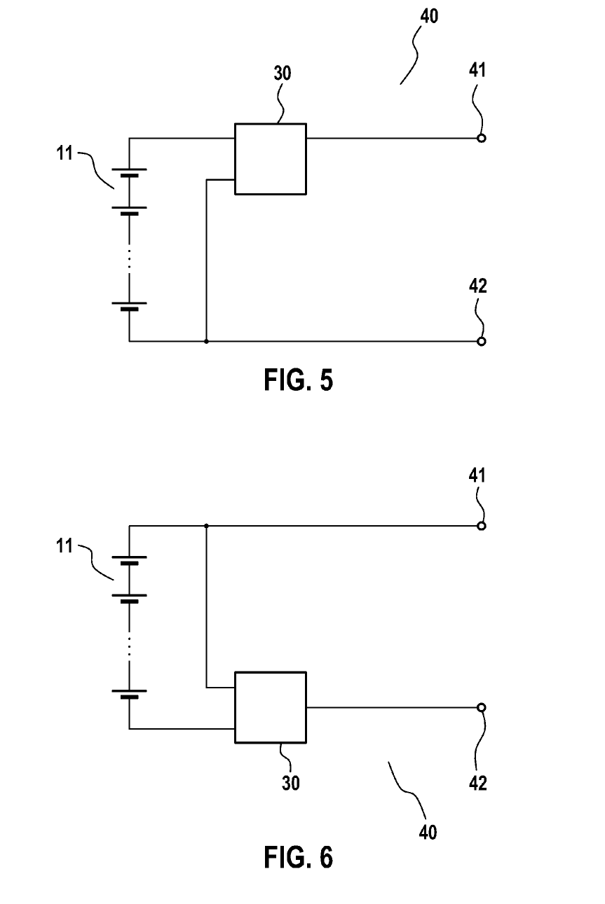

FIGS. 5 and 6 show two embodiments of a converter cell module 40 with the first embodiment of the coupling unit 30. A plurality of converter cells 11, which are configured here as electrochemical battery cells, are connected in series between the inputs of the coupling unit 30. Instead of battery cells, solar cells, for example, could also be used as converter cells.

However, the invention is not restricted to a series connection of converter cells 11, as is shown in the figures; rather, just a single converter cell 11, or else a parallel connection or mixed series and parallel connection of converter cells 11, can be provided. In the example of FIG. 5, the output of the coupling unit 30 is connected to a first terminal 41 and the negative pole of the converter cells 11 is connected to a second terminal 42. However, as in FIG. 6, an almost mirror-image arrangement is possible, in which the positive pole of the converter cells 11 is connected to the first terminal 41 and the output of the coupling unit 30 is connected to the second terminal 42.

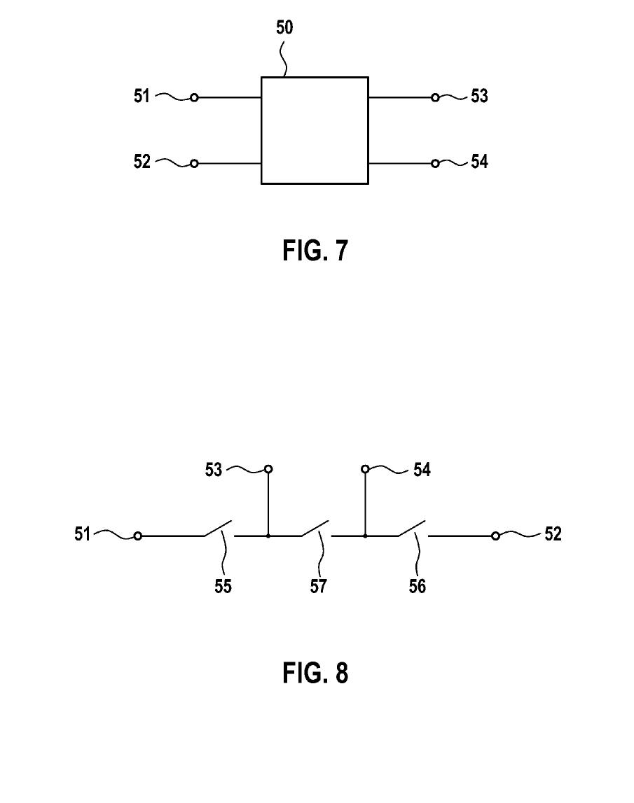

FIG. 7 shows a second embodiment of a coupling unit for use in the energy converter according to the invention. The coupling unit 50 has two inputs 51 and 52 and also two outputs 53 and 54. It is configured to connect either the first input 51 to the first output 53 and the second input 52 to the second output 54 (and to decouple the first output 53 from the second output 54) or else to connect the first output 53 to the second output 54 (and at the same time to decouple the inputs 51 and 52). In specific embodiments of the coupling unit, the latter can be additionally configured to disconnect both inputs 51, 52 from the outputs 53, 54 and also to decouple the first output 53 from the second output 54. However, provision is not made to connect both the first input 51 to the second input 52.

FIG. 8 shows a possible circuit implementation of the second embodiment of the coupling unit 50, in which a first, a second and a third switch 55, 56 and 57 are provided. The first switch 55 is connected between the first input 51 and the first output 53; the second switch 56 is connected between the second input 52 and the second output 54; and the third switch 57 is connected between the first output 53 and the second output 54. This embodiment likewise offers the advantage that the switches 55, 56 and 57 can be realized simply as semiconductor switches such as MOSFETs or IGBTs. Semiconductor switches have the advantage of being cheap and having a high switching speed, such that the coupling unit 50 can react to a control signal or to a change in the control signal within a short period of time and high switching rates are achievable.

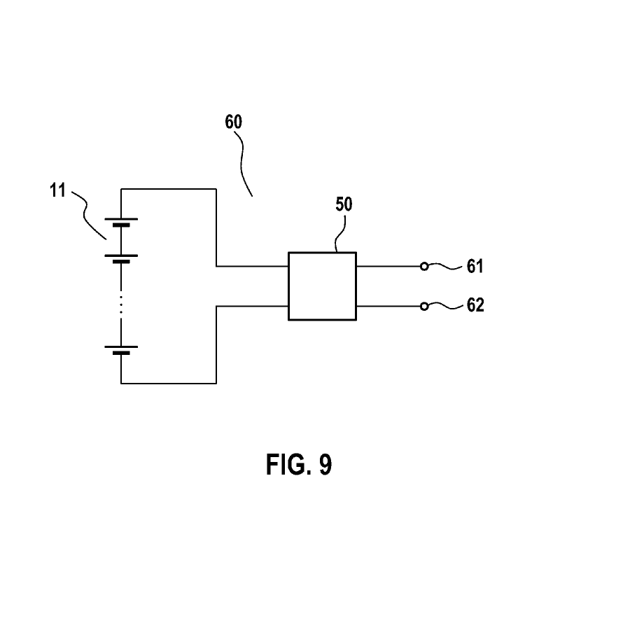

FIG. 9 shows an embodiment of a converter cell module 60 with the second embodiment of the coupling unit 50. A plurality of converter cells 11, which are embodied as battery cells, again without limiting generality, are connected in series between the inputs of a coupling unit 50. This embodiment of the converter cell module 60 is also not restricted to a series connection of converter cells 11; again, just a single converter cell 11, or else a parallel connection or mixed series and parallel connection of converter cells 11, can be provided. The first output of the coupling unit 50 is connected to a first terminal 61 and the second output of the coupling unit 40 is connected to a second terminal 62. Compared to the converter cell module 40 of FIGS. 5 and 6, the converter cell module 60 offers the advantage that both sides of the converter cells 11 can be decoupled from the rest of the energy converter by the coupling unit 50, which enables safe replacement in the course of operation, since the dangerous high total voltage of the remaining converter cell modules of the energy converter is not present at any pole of the converter cells 11.

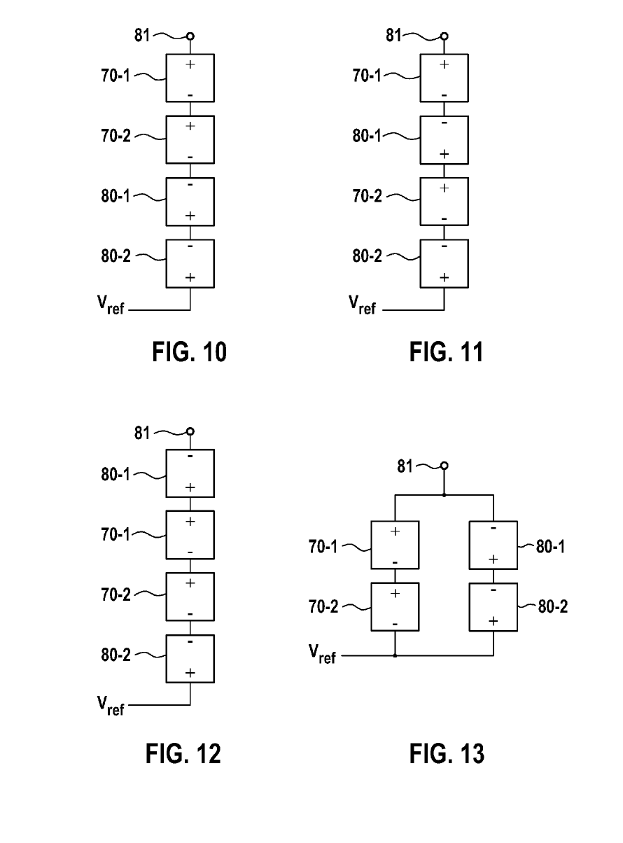

FIGS. 10 to 13 show embodiments of the energy converter according to the invention. A common feature of the embodiments is that they have two converter cell modules 70-1 and 70-2 having a first polarity and two converter cell modules 80-1 and 80-2 having an opposite second polarity in each case. The converter cell modules 70-1, 70-2, on the one hand, and 80-1, 80-2, on the other, may be of identical internal design but are connected up externally in opposite directions. The invention can of course be constructed with just one converter cell module for each of the two polarities or else with larger numbers than two in each case. Preferably, however, the same number of converter cell modules is provided for each polarity.

In FIG. 10, the converter cell modules 70-1, 70-2, 80-1 and 80-2 are connected in series between an output terminal 81 of the energy converter and a reference potential (usually ground), wherein the converter cell modules are connected up such that in each case a partial section comprising the converter cell modules 70-1, 70-2 of the first polarity and one comprising the converter cell modules 80-1, 80-2 of the second polarity are obtained, which are in turn connected in series. However, as shown in FIG. 11, it is also possible to connect together in each case one converter cell module 70-1 or 70-2 of the first polarity and one converter cell module 80-1 or 80-2 of the second polarity to form a partial section, and to cascade a plurality of mixed partial sections such as these. In principle, however, any sequence of converter cell modules is possible, regardless of the polarity thereof, as is illustrated by way of example in FIG. 12. However, it is not necessary to connect all of the converter cell modules in series. FIG. 13 shows an exemplary embodiment in which the converter cell modules 70-1, 70-2 of the first polarity are connected together to form a first partial section and the converter cell modules 80-1, 80-2 of the second polarity are connected together to form a second partial section and the two partial sections are connected in parallel between the output terminal 81 and the reference potential. In this case, at least one converter cell module of that partial section which is inactive is switched to a high-impedance condition in order not to short the active converter cell modules of the other partial section via the inactive partial section. This means that, for the exemplary embodiment in FIG. 13, at least one converter cell module 60 having the second embodiment of the coupling unit 50 from FIGS. 8 and 9 should be provided in each partial section.

The energy converter can additionally have charging and disconnection devices or disconnection devices as provided in FIG. 2, if these are required by safety regulations. However, such disconnection devices are not necessary according to the invention, as decoupling of the converter cells 11 from the connections of the energy converter can be effected by the coupling units contained within the converter cell modules.

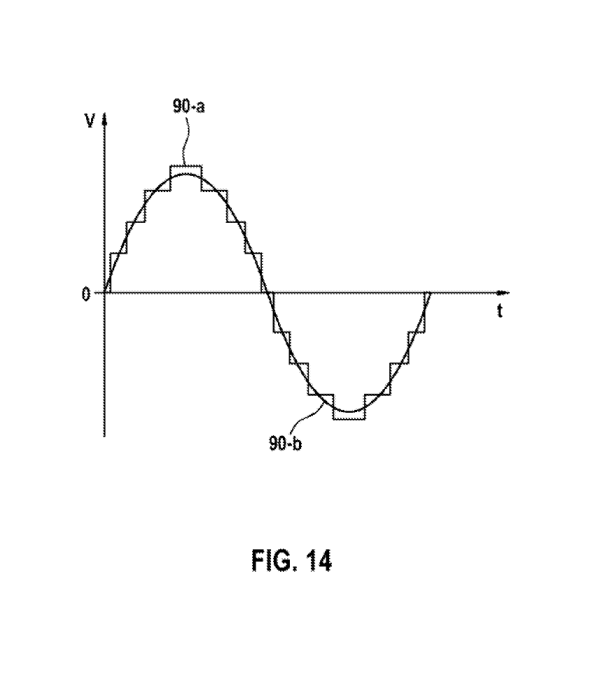

FIG. 14 shows an example of a temporal profile for an output voltage of the energy converter according to the invention. Here, the output voltage of the energy converter V is plotted against the time t. A sine, which is desired (ideal) for an example application and has a positive and a negative half cycle, is designated by the reference numeral 90-b. The ideal sine is generated approximately by the energy converter according to the invention by means of a discrete-value voltage curve 90-a. The sizes of the deviations of the discrete-value voltage curve 90-a from the ideal curve 90-b depend on the number of converter cells 11 which are connected in series in a battery module 40 or 60 and on the respective cell voltage of said converter cells. The fewer converter cells 11 there are connected in series in a converter cell module, the more accurately the discrete-value voltage curve 90-a can follow the idealized curve 90-b. In conventional applications, the proportionately small deviations do not adversely affect the function of the overall system, however. Compared to a conventional pulse-controlled inverter, which can only provide a binary output voltage that must then be filtered by the downstream circuit components, the deviations are significantly reduced.

1. An energy converter for outputting electrical energy, comprising:
at least one first converter cell module; and
at least one second converter cell module,
wherein the first and second converter cell modules comprise at least one converter cell and one coupling unit,
wherein the at least one converter cell is connected between a first input and a second input of the coupling unit,
wherein the coupling unit is configured (i) to connect the at least one converter cell between a first terminal of the converter cell module and a second terminal of the converter cell module in response to a first control signal, and (ii) to connect the first terminal to the second terminal in response to a second control signal, and
wherein the at least one converter cell of the at least one first converter cell module is connected in a first polarity between the first input and the second input of the coupling unit of the at least one first converter cell module and the at least one converter cell of the at least one second converter cell module is connected in a second polarity, which is opposite to the first polarity, between the first input and the second input of the coupling unit of the at least one second converter cell module.

2. The energy converter as claimed in claim 1, further comprising:
a control unit, which is configured to output the first control signal to the at least one first converter cell module and to output the second control signal to the at least one second converter cell module during a first period and to output, in a second period following the first period, the second control signal to the at least one first converter cell module and to output the first control signal to the at least one second converter cell module, and thus to set an output voltage for the energy converter to have a first arithmetic sign during the first period and to have a second arithmetic sign, which is opposite to the first arithmetic sign, during the second period.

3. The energy converter as claimed in claim 2, further comprising:
a plurality of the first converter cell modules; and
a plurality of the second converter cell modules,
wherein the control unit is configured to set a sinusoidal output voltage.

4. The energy converter as claimed in claim 3, wherein the control unit is configured to set the sinusoidal output voltage to have a predefinable frequency.

5. The energy converter as claimed in claim 1, wherein the coupling unit has a first output and is configured to connect either the first input or the second input to the first output in response to the first control signal.

6. The energy converter as claimed in claim 1, wherein the coupling unit has a first output and a second output and is configured to connect the first input to the first output and the second input to the second output in response to the first control signal, and to disconnect the first input from the first output and the second input from the second output and to connect the first output to the second output in response to the second control signal.

7. The energy converter as claimed in claim 1, wherein the at least one converter cells are battery cells.

8. The energy converter as claimed in claim 1, wherein the at least one converter cells are solar cells.

9. A motor vehicle comprising:
an electric drive motor configured to drive the motor vehicle; and
an energy converter, which is connected to the electric drive motor,
wherein the energy converter is configured to output electrical energy and includes at least one first converter cell module, and at least one second converter cell module,
wherein the first and second converter cell modules comprise at least one converter cell and one coupling unit,
wherein the at least one converter cell is connected between a first input and a second input of the coupling unit,
wherein the coupling unit is configured (i) to connect the at least one converter cell between a first terminal of the converter cell module and a second terminal of the converter cell module in response to a first control signal, and (ii) to connect the first terminal to the second terminal in response to a second control signal, and
wherein the at least one converter cell of the at least one first converter cell module is connected in a first polarity between the first input and the second input of the coupling unit of the at least one first converter cell module and the at least one converter cell of the at least one second converter cell module is connected in a second polarity, which is opposite to the first polarity, between the first input and the second input of the coupling unit of the at least one second converter cell module.

10. A method for supplying power to an electric drive system comprising:
connecting an energy converter to an electric drive system; and
setting an output voltage for the energy converter to have a first arithmetic sign during a first period and to have a second arithmetic sign, which is opposite to the first arithmetic sign, during a second period,
wherein the energy converter is configured to output electrical energy and includes at least one first converter cell module, and at least one second converter cell module,
wherein the first and second converter cell modules comprise at least one converter cell and one coupling unit,
wherein the at least one converter cell is connected between a first input and a second input of the coupling unit,
wherein the coupling unit is configured (i) to connect the at least one converter cell between a first terminal of the converter cell module and a second terminal of the converter cell module in response to a first control signal, and (ii) to connect the first terminal to the second terminal in response to a second control signal, and
wherein the at least one converter cell of the at least one first converter cell module is connected in a first polarity between the first input and the second input of the coupling unit of the at least one first converter cell module and the at least one converter cell of the at least one second converter cell module is connected in a second polarity, which is opposite to the first polarity, between the first input and the second input of the coupling unit of the at least one second converter cell module.
